(19) United States
(12) Patent Application Publication
(10) Pub. No.: US 2026/0219905 A1
(43) Pub. Date: Jul. 30, 2026

(54) HYPER PERSONALIZED VIRTUAL ASSISTANT WITH CONVERSATIONAL ARTIFICIAL INTELLIGENCE CAPABILITIES

(71) Applicant: WELLS FARGO BANK, N.A., San Francisco, CA (US)

(72) Inventors: Abhijit Nandan Kuwar, Phoenix, AZ (US); Mandar Nandkumar Shasane, Phoenix, AZ (US); Ram Gopal, Dublin, CA (US); Sundarapandian Sethuramachandran, Chandler, AZ (US); Nishit Kumar Thakur, Fremont, CA (US); Raghavendra Rao, Cary, NC (US); Prateek Singh, Phoenix, AZ (US)

(21) Appl. No.: 19/040,690

(22) Filed: Jan. 29, 2025

(51) Int. Cl. G06F 9/451; G06F 3/0482; G06F 40/35

(52) U.S. Cl. CPC G06F 9/453; G06F 3/0482; G06F 40/35

(57) ABSTRACT

Systems and methods for hyper personalized virtual assistant responses are provided. A method includes establishing a virtual communication session with a user having a user profile and extracting session data associated with the user. The method also includes determining contextual information associated with the session data and partitioning the session data into predefined categories. The method also includes generating a plurality of insights, scoring each insight in terms of a respective probability that the insight will be of interest to the user, and outputting the insights for display for the user in an order associated with the scores.

### TECHNICAL FIELD

The present disclosure generally relates to natural language processing, and more particularly to a hyper personalized virtual assistant with conversational artificial intelligence (AI) capabilities.

### BACKGROUND

Natural language processing (“NLP”) techniques employing machine learning (“ML”) models are a core component in natural language understanding (“NLU”), enabling development of effective virtual assistant applications. ML models are trained on vast datasets to draw inferences on human-like text and provide human-like output. One type of ML model used for this purpose is a large language model (“LLM”) which can provide more accurate, relevant, and context-aware responses, significantly improving user interactions and satisfaction. Despite the recent advances in the field of NLP, there is a need in the art for improved virtual assistant applications capable of providing hyper personalized responses.

### SUMMARY

Certain aspects and features of the present disclosure generally relate to NLP, and more particularly to a hyper personalized virtual assistant with conversational AI capabilities. According to an aspect of the present disclosure, a method of generating hyper personalized virtual assistant responses includes: establishing a virtual communication session with a user having a user profile; extracting, based on the user profile, session data associated with the user from a plurality of data sources; determining, using an orchestration model comprising at least one machine learning (ML) model, contextual information associated with the session data; partitioning, using the orchestration model and based on the determined contextual information, the session data into one or more predefined categories thereby creating a plurality of categorical datasets; generating, using an insights network comprising a plurality of ML models, a plurality of insights for each categorical dataset of the plurality of categorical datasets; scoring, using a scoring algorithm, each insight of the plurality of insights, wherein a respective score of each insight is associated with a respective probability that the insight is of interest to the user; identifying a first insight as a best insight based on the respective probability of the first insight being a best score of a plurality of scores; and outputting, for display on a user interface, the plurality of insights in a display order based on the score, wherein the display order prioritizes the first insight.

The above methods may be implemented in a cloud service executed on cloud service provider infrastructure, which may include various servers, processors, and databases. The above methods can also be implemented as computer-executable program instructions stored in a non-transitory, tangible computer-readable medium or media and/or operating within a system including one or more processors or other processing device and memory.

An additional example includes a system including one or more processors. The system also includes a memory coupled to the one or more processors. The memory includes instructions that when executed by the one or more processors, causes the one or more processors to: establish a virtual communication session with a user having a user profile; extract, based on the user profile, session data associated with the user from a plurality of data sources; determine, using an orchestration model comprising at least one machine learning (ML) model, contextual information associated with the session data; partition, using the orchestration model and based on the determined contextual information, the session data into one or more predefined categories thereby creating a plurality of categorical datasets; generate, using an insights network comprising a plurality of ML models, a plurality of insights for each categorical dataset of the plurality of categorical datasets; score, using a scoring algorithm, each insight of the plurality of insights, wherein a respective score of each insight is associated with a respective probability that the insight is of interest to the user; identify a first insight as a best insight based on the respective probability of the first insight being a best score of a plurality of scores; and output, for display on a user interface, the plurality of insights in a display order based on the score, wherein the display order prioritizes the first insight.

An additional example includes a non-transitory computer-readable medium embodying program code that is executable by one or more processors to cause the one or more processors to: establish a virtual communication session with a user having a user profile; extract, based on the user profile, session data associated with the user from a plurality of data sources; determine, using an orchestration model comprising at least one machine learning (ML) model, contextual information associated with the session data; partition, using the orchestration model and based on the determined contextual information, the session data into one or more predefined categories thereby creating a plurality of categorical datasets; generate, using an insights network comprising a plurality of ML models, a plurality of insights for each categorical dataset of the plurality of categorical datasets; score, using a scoring algorithm, each insight of the plurality of insights, wherein a respective score of each insight is associated with a respective probability that the insight is of interest to the user; identify a first insight as a best insight based on the respective probability of the first insight being a best score of a plurality of scores; and output, for display on a user interface, the plurality of insights in a display order based on the score, wherein the display order prioritizes the first insight.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is an example system that can establish a virtual communication session to provide hyper personalized virtual assistant responses, according to one or more aspects of the present disclosure;

FIG. 2 is an example data flow diagram of a virtual assistant platform configured to provide hyper personalized virtual assistant responses, according to one or more aspects of the present disclosure;

FIG. 3 is a flowchart of an example of a process that provides hyper personalized virtual assistant responses, according to one or more aspects of the present disclosure;

FIG. 4 is a flowchart of an example of a process that provides hyper personalized virtual assistant responses, according to one or more aspects of the present disclosure;

FIG. 5 is a block diagram illustrating an example computer-readable medium or computer-readable device including processor-executable instructions configured to embody one or more aspects of the present disclosure; and

FIG. 6 and the following discussion provide a description of a suitable computing environment to implement embodiments of one or more aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

Virtual assistant applications have become a common way for people to obtain information and/or perform actions. People can interact with a virtual assistant from their personal computers, mobile phones, or otherwise, and provide requests (herein referred to as “text input(s),” “user input(s),” and/or “requests”) to the virtual assistant. The virtual assistant can process the text input and generate a response answering a question contained in the request, perform an action on behalf of the user, provide advice or suggestions to the user, and so on. NLU is at the core of effective virtual assistant applications, where virtual assistant applications employ NLP techniques to quickly decipher (e.g., interpret) vast amounts of data to provide a generative response to the user that is likely to serve the user's underlying goal or purpose of the interaction (e.g., the user's intent). In particular, virtual assistant applications leverage advances in AI and machine learning (“ML”) to interpret user data, including historical transaction data associated with the user, as well as real-time inputs received from the user. Such AI and ML techniques incorporated into virtual assistant applications can increase productivity of a user, increase the knowledge base of a user, and/or provide proactive suggestions to a user, all without the need for preconfigured responses or live human interaction. Such capabilities can greatly enhance customer experiences in the enterprise context and such capabilities greatly expand enterprise capabilities as an enterprise can interact with hundreds, thousands, and even more customers simultaneously.

One illustrative example of the present disclosure includes a virtual assistant platform that can provide hyper personalized virtual assistant responses utilizing AI/ML capabilities. The virtual assistant platform, which can be accessed by a client device via a network configured to host a virtual communication session, can include a variety of subsystems each including a variety of ML models configured to process user data and provide insights and/or generative responses for display on the client device. In particular, the illustrative example of the virtual assistant platform includes an orchestration subsystem, an insights subsystem, and a virtual assistant subsystem.

The orchestration subsystem receives an indication from the client device that a user has initiated a virtual communication session. The user is authenticated based on one or more user authentication methods such as a username, password, biometrics, and/or any combination (e.g., multi-factor authentication) of the various methods. Upon authentication of the user, the orchestration subsystem, employing one or more ML model(s), dynamically extracts session data associated with the user and/or enterprise from a variety of data sources. Session data refers to data extracted from a variety of sources including, but not limited to, data associated with a publicly facing website of an enterprise that maintains the virtual assistant platform, transaction history (e.g., deposits, withdrawals, spending, etc.) of an account associated with the user, select documents (e.g., terms and conditions, fee schedules, and the like) associated with an enterprise, and other sources of session data as described herein.

The one or more ML model(s) of the orchestration subsystem perform classification of the session data. For instance, the orchestration subsystem analyzes the session data and categorizes the session data into predetermined categories. One category may include session data associated with transaction history of the user. Another category may include session data associated with intents or goals of the user (e.g., data associated with a user's underlying purpose or goal, such as saving for a house). A third category (in context of a financial enterprise) may include session data associated with creditworthiness of a user. In some examples, some session data may be included in multiple categories. Additionally, one or more parameters of the orchestration subsystem can define the scope of the session data to be extracted (e.g., a predetermined timing window for which the session data is extracted, such as all session data associated with the user for the previous 365 days). The trained ML model(s) utilized by the orchestration subsystem may be any suitable classification model such as Dual Intent and Entity Transformer (“DIET”) models, Bidirectional Encoder Representations from Transformers (“BERT”) based models, Convolutional Neural Networks (“CNNs”), including future versions of any of these or other classification models, trained to perform classification tasks on data.

Once the session data is extracted and categorized, the categorical datasets are provided to an insights subsystem of the virtual assistant platform. Similar to the orchestration model, the insights subsystem also includes one or more trained ML model(s). Rather than performing classification of the session data, the ML model(s) of the insights subsystem are trained to generate “insights” based on the session data. More specifically, the various ML model(s) of the insights subsystem are specifically trained (e.g., fine-tuned) to provide insights on specific categorical datasets where “insights” refer to a text output that includes advice, recommendations, summarized information, predictions, and so on based on the session data. The insights are presented on the client device to provide the user with actionable information as it relates to their user specific session data that was analyzed. The ML model(s) employed by the insights subsystem may include ML models of any suitable type that are trained to provide predictive (e.g., generative) responses. Such ML models may include, for example, large language models (“LLM”) such as Language Model for Dialogue Applications (or “LaMDA”) (e.g., Google Gemini), ChatGPT-3, ChatGPT-3.5, ChatGPT-4, DeepMind Sparrow, Claude 3, including future versions of any of these or other LLMs suitable to provide generative responses.

In more detail, the various ML model(s) of the insights subsystem are specifically trained for the particular categorical dataset generated by the orchestration subsystem. For example, a first set of ML model(s) included in the insights subsystem is specifically trained to provide generative responses associated with the intents or goals of the user. In a financial context, a user may have indicated on their user profile they are saving for a house. The orchestration model, upon instantiation of a virtual communication session, dynamically extracts all session data related to the user and categorizes the session data using the above-described classification models. The classification models identify that a recurrent deposit, related to an employer payout, in the user's checking account is session data that is categorized as being relevant to a home savings goal. Next, when the insights subsystem receives the categorical dataset related to intents or goals of the user, the insights subsystem routes the categorical dataset to the ML model(s) specifically trained to generate insights associated with the intents or goals of the user. The ML model(s) may extract the relevant features from the session data, such as key values, timing of payment, amount of payment, etc. and draw inferences and predictive patterns on the features. The insight subsystem may then generate “an insight” (e.g., advice, a recommendation, an informative text output, etc.) that describes to the user how much the user should try to save from each paycheck to reach their goal in the fastest manner possible. The insight may be displayed for viewing by the user, where the user can interact with the insight such as by clicking, tapping, etc. to learn more about the insight.

The virtual assistant platform also includes a virtual assistant subsystem providing for additional features and functionality. As mentioned above, after the insights are generated by the insights subsystem and displayed for the user on the respective client device, the user may interact with the insights such as by clicking, tapping, etc. to learn more about the insight. As part of this interaction, the user may have questions about the insight or the user may want to learn more about the insight. As such, responsive to the user interacting with the insight, a chat box may be generated for display on the client device. The chat box, which a user may type into or speak into (e.g., where the user's speech is converted to text using any suitable speech-to-text software of the virtual assistant platform), may activate an instance of a virtual assistant included in the virtual assistant subsystem. The user can begin a chat conversation with the virtual assistant to ask the virtual assistant questions about the respective insights.

Similar to the orchestration subsystem and the insights subsystem, the virtual assistant subsystem includes one or more ML model(s) configured to perform NLP techniques on the user request. For example, a first ML model (or a first subset of ML model(s)) of the virtual assistant subsystem can perform intent classification on the user input. As discussed above, intent classification refers to the process of determining an underlying purpose or goal of the user as associated with the text input. Typically, intent classification models are trained on a dataset of user requests paired with their respective intent labels and the intent classification models learns to extract relevant features from the text input, such as keywords, phrases, and grammatical structure. After extracting the user intent, the virtual assistant subsystem employs additional ML model(s) configured to provide a generative response to the user input. The additional ML model(s) may be a trained ML model(s) of any suitable type that have been trained to provide natural language responses to text inputs. For example, the additional ML model(s) can be LLMs or any other suitable ML model configured to provide a generative response. Because generative response generation by the virtual assistant subsystem employs ML model(s) that accepts natural language queries and prompts, in some examples, the additional ML model(s) are provided a prompt including constraints that enable the generated response to be narrowly tailored according to the preferences of a particular user or administrator of the virtual assistant platform. For instance, one type of constraint can instruct the additional ML model(s) to consider session data, as described above.

After the user input is processed and a response is generated, the virtual assistant platform monitors for additional requests (e.g., additional text inputs) from the client device. If additional inputs are received (e.g., by virtue of a follow up response from the user or by virtue of the user selecting one or more additional insights), the virtual assistant platform begins the intent classification and generative response generation processing steps again. The virtual interaction with the virtual assistant platform continues until the user has no more requests or the client device associated with the user disconnects from the virtual assistant platform. It will be appreciated that new insights may be generated for each subsequent virtual communication session instantiated by the user as new session data is dynamically added and/or removed from the data sources that are evaluated by the orchestration subsystem. As such, the insights are dynamic and are continuously updated and modified based on new information learned by the respective ML model(s).

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods are provided below in relation to the drawings.

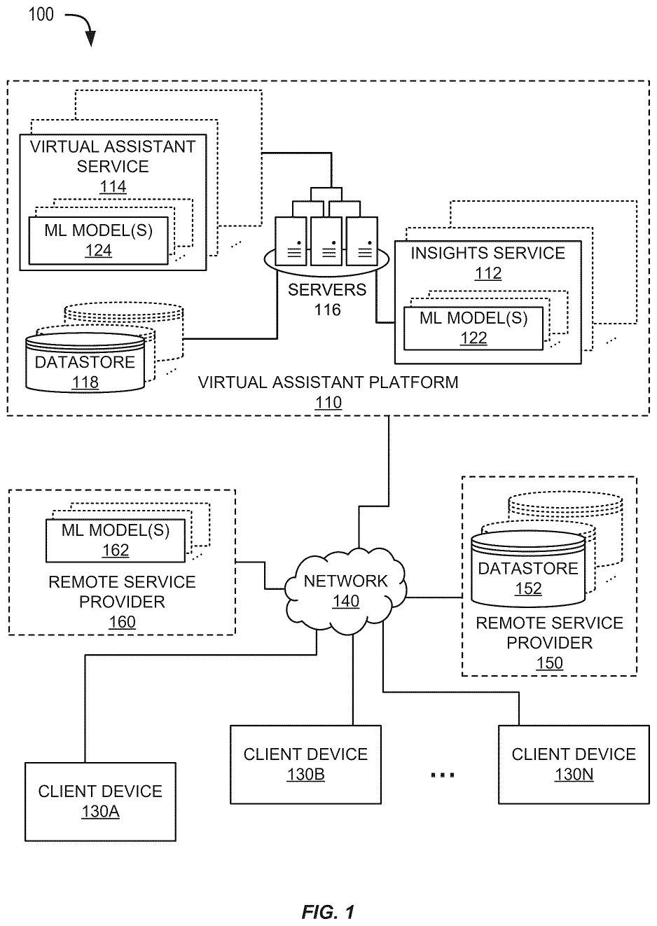

Referring now to FIG. 1, FIG. 1 is an example system 100 that can establish a virtual communication session to provide hyper personalized virtual assistant responses, according to one or more aspects of the present disclosure. In this example system 100, a virtual assistant platform 110 and a number of client devices 130A-130N (which may be referred to herein individually as a “client device 130” or collectively as the “client devices 130”) are connected via a network 140. Network 140 can be the internet or any suitable communications network or combination of communications network may be employed, including LANs (e.g., within a corporate private LAN), WANs, MANs, cellular network (e.g., 3G, 4G, 4G LTE, 5G, etc.), or any combination of these.

The client devices 130A-130N can be any suitable computing or communications device. For example, client devices 130A-130N may be desktop computers, laptop computers, tablets, smart phones having processors and computer-readable media, connected to the virtual assistant platform 110 using the internet, via a smartphone or desktop application, or other suitable computer network. The client devices 130A-130N have communication software installed to enable them to connect to the virtual assistant platform 110 to view insights generated by insights service 112 or to chat with a virtual assistant hosted by virtual assistance service 114.

In more detail, client devices 130A-130N may initiate a virtual communication session hosted by the virtual assistant platform 110 by connecting, via network 140, to the virtual assistant platform 110. Upon initiation of the virtual communication session, the virtual assistant platform 110 operates a number of servers 116 that can provide for hyper personalized virtual assistant responses for the virtual communication session. As shown in FIG. 1, hyper personalized virtual assistant responses are provided by one or more instances of insights service 112 and/or one or more instances of virtual assistant service 114 that can be executed and allocated to or used by virtual communication sessions hosted by the one or more servers 116 of the virtual assistant platform 110 for the various client devices 130A-130N. The insights service 112 may include one or more ML model(s) 122 specifically trained to generate insights (e.g., text outputs that include advice, recommendations, summarized information, predictions, etc.) based on session data (e.g., session data stored in datastore 118 and/or session data stored in datastore 152 hosted by remote service provider 150) associated with the user of the respective client device 130. The virtual assistant service 114 may similarly include one or more ML model(s) 124 specifically trained to provide generative responses to the user client device 130 based on text input received from the client device 130.

To generate insights, insights service 112 may extract session data associated with the user of the respective client device from one or more datastores, such as datastore 118. The ML model(s) 122 may extract the relevant features from the session data, such as key values, timing of payment, amount of payment, etc. and draw inferences and predictive patterns on the features. The insights service 112 may then generate “an insight” (e.g., advice, a recommendation, an informative text output, etc.) that describes to a user how much the user should try to save from each paycheck to reach their goal in the fastest manner possible. The insight may be displayed for viewing by the user on the client device 130, where the user can interact with the insight such as by clicking, tapping, etc. to learn more about the insight.

As part of the virtual communication session, the user may have questions about the insight or the user may want to learn more about the insight. As such, responsive to the user interacting with the insight, a chat box may be generated for display on the client device. The chat box allows the user to input a text input into the chat window provided on a graphical user interface (“GUI”) displayed on the client devices 130. In some cases, the interacted GUI may employ speech-to-text functionality where a user of one of the client devices may speak into the interface and the speech may be converted to text input using any conventional speech-to-text functionality software.

The user of a client device may want to interact with the insights generated by the insights service 112 for a variety of reasons. For example, the user may want to obtain additional information about the insight. In addition, the user may have questions regarding how the insight was generated, for example, what sources of session data were used to generate the insight. Moreover, the user may want the virtual assistant platform 110 to generate an insight that has not yet been presented, such as if the user has a specific question or needs advice about a particular problem. In some examples where the virtual assistant platform 110 is hosted by a financial institution, the user may have general questions related to their personal finances such as “how can I save money better” or “what is the best route to achieving a certain financial goal.” To obtain answers and guidance to these requests, virtual assistant platform 110 may initiate an instance of the virtual assistant service 114.

Responsive to initiation of an instance of the virtual assistant service 114, the ML model(s) 124 may receive the request as input. At least one ML model of the ML model(s) 124 may perform intent classification on the request to determine an underlying purpose or goal of the request. The intent classification models are trained on a dataset of user requests paired with their respective intent labels and the intent classification models learns to extract relevant features from the text input, such as keywords, phrases, and grammatical structure. Example intent classification models include DIET models, BERT based models, CNNs, and so on.

After extracting the user intent, the virtual assistant subsystem employs additional ML model(s) of the ML model(s) 124 configured to provide a generative response to the user input. The additional ML model(s) may be a trained ML model(s) of any suitable type that have been trained to provide natural language responses to text inputs. For example, the second language model can be a LLM such as LaMDA, ChatGPT-3, ChatGPT-3.5, ChatGPT-4, DeepMind Sparrow, Claude 3, including future versions of any of these or other LLMs suitable to generate a generative response. In additional to using the additional ML model(s) to generate a generative response, in some examples, the additional ML model(s) may also be provided with a prompt (e.g., a prompt is provided in addition to the user's intent and request). In more detail, and because response generation employs suitable ML model(s) such as LLMs, which accepts natural language queries and prompts, a prompt including constraints can enable the generated response to be tailored according to the preferences of a particular user or administrator of the virtual assistant platform. For instance, one type of constraint can instruct the additional ML model(s) to consider session data. Another type of constraint can specify a particular natural language (e.g., English, Spanish). Another type of constraint can specify a particular format for the generative response (e.g., paragraphs, bullet-points, etc.). Another type of constraint can specify a character length where text inputs that exceed or otherwise satisfy a character length threshold are labeled as non-compliant. The prompt may not be visible to the user interacting with the virtual assistant service 114, but rather the prompt may be considered a “system prompt” that is defined and controlled by an enterprise hosting the virtual assistant platform 110.

After the request is processed and a response is generated by virtual assistant service 114, the virtual assistant platform 110 monitors for additional requests from the user. If additional inputs are received (e.g., by virtue of a follow up response from the user or by virtue of the user selecting one or more additional insights), virtual assistant service 114 of the virtual assistant platform 110 begins the intent classification and generative response generation processing steps again. The generated insights and generative responses provided to the client devices 130A-130N continues for the duration of the virtual communication session until the client devices 130A-130N disconnect (e.g., after a period of inactivity, manual disconnection, etc.).

Also included in FIG. 1 is a remote service provider 160. Remote service provider 130 also may include one or more ML model(s) 162. Similar to the language models and/or classification models included in insights service 112 and/or the virtual assistant service 114, ML model(s) 162 may also be ML model(s) of any suitable type to perform the techniques described herein. For example, ML model(s) 162 may include any suitable intent classification models (e.g., DIET models, BERT based models, CNNs, and so on) as well as any suitable generative language models (e.g., LLMs of any suitable type (e.g., Google Gemini, ChatGPT-3, ChatGPT-3.5, ChatGPT-4, DeepMind Sparrow, Claude 3, and so on)), including future versions of any of these or other ML model(s), to perform the techniques described above with respect to insights service 112 and virtual assistant service 114.

Remote service provider 130 is connected via network 140 to the virtual assistant platform 110. In some examples, instead of the virtual assistant platform 110 utilizing one or more servers 116 to allocate services, such as insights service 112 and virtual assistant service 114, one or more of insights service 112 and/or virtual assistant service 114 may access ML model(s) 162 hosted by remote service provider 160. In these examples, ML model(s) 162 need not be incorporated into the virtual assistant platform 110. Rather, the ML model(s) 162 can be a remotely accessible external resource usable by the one or more components of the virtual assistant platform 110 to facilitate functionality of the virtual communication session.

Also included in FIG. 1 is remote service provider 150. Remote service provider 150 includes one or more datastores 152. Similar to remote service provider 160, remote service provider 150 may store data at a remote storage location that is accessible, via network 140, by virtual assistant platform 110. For instance, datastore 152 may store additional session data that may be used by insights service 112 and/or virtual assistant service 114 to provide the hyper personalized virtual assistant responses during the virtual communication session. It will be appreciated that in some examples, remote service provider 160 and remote service provider 150 may be separate or similar entities to the entity hosting or in control of the virtual assistant platform 110.

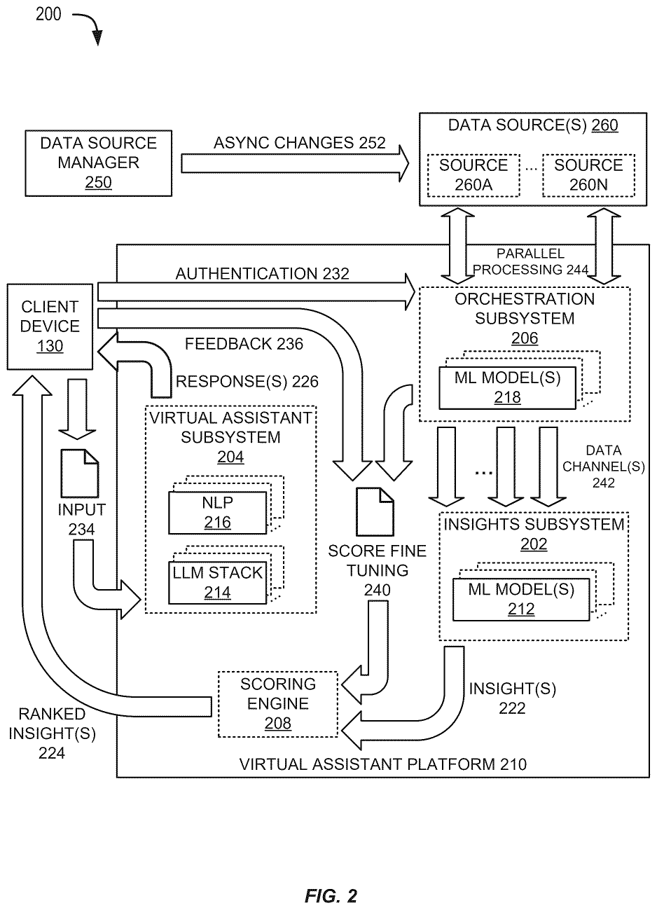

Referring now to FIG. 2, FIG. 2 is an example data flow diagram 200 of a virtual assistant platform 210 configured to provide hyper personalized virtual assistant responses, according to one or more aspects of the present disclosure. The virtual assistant platform 210 in this example has been configured to host a virtual communication session between one or more client devices, such as client device(s) 130A-130N described with respect to FIG. 1. The virtual assistant platform 210 includes insights subsystem 202, virtual assistant subsystem 204, orchestration subsystem 206, and scoring engine 208. The combination of subsystems and engines included in virtual assistant platform 210 are configured to generate ranked insight(s) 224 and/or response(s) 226 to client device 130 using a plurality of ML and NLP models such as ML model(s) 212 of insights subsystem 202, NLP 216 and LLM stack 214 of virtual assistant subsystem 204, and ML model(s) 218 of orchestration subsystem 206.

Beginning at the top portion of the data flow diagram 200 of FIG. 2, virtual assistant platform 210 may receive a request from client device 130 requesting to initiate a virtual communication session between the virtual assistant platform 210 and the client device 130. A user of client device 130 may be authenticated by the virtual assistant platform 210 via authentication 232. Authentication 232 may be any suitable type of authentication mechanism including, but not limited to, a username, password, biometrics, and/or any combination (e.g., multi-factor authentication) of the various mechanisms. Responsive to successful authentication 232, orchestration subsystem may perform parallel processing 244 to extract and receive session data from data source(s) 260. As shown in FIG. 2, data source(s) 260 can include a variety of sources 260A-260N that may store data associated with the user of the client device 130. As mentioned previously with respect to FIG. 1, session data stored in data source(s) 260 can include data associated with a publicly facing website of an enterprise that maintains the virtual assistant platform, transaction history (e.g., deposits, withdrawals, spending, etc.) of an account associated with the user, select documents (e.g., terms and conditions, fee schedules, and the like) associated with an enterprise.

Additionally, the data stored in data source(s) 260 may dynamically update responsive to asynchronous changes 252 received from data source manager 250. For instance, data source manager 250 may provide instructions and/or commands to data source(s) 260 to dynamically update the sources of data included in source 260A-260N. As one particular example, source 260A may include a historical list of deposits and withdrawals out of a particular checking account associated with the user of client device 130. Asynchronous changes 252 provided by data source manager 250 may define a timing window for collecting the historical list of deposits and withdrawals (e.g., all deposits and withdrawals from the previous 365 days). Parallel processing 244 performed by orchestration subsystem 206 can call for such data from sources 260A-260N in parallel with aggregation of the data for processing.

Once all the relevant session data is extracted and aggregated by orchestration subsystem 206, orchestration subsystem 206 can use ML model(s) 218 to classify the session data into categorical datasets. For instance, the orchestration subsystem 206 can analyze the session data and categorize the session data into predetermined categories. As mentioned previously, one example category may include session data associated with transaction history of the user; another category may include session data associated with intents or goals of the user (e.g., data associated with a user's underlying purpose or goal, such as saving for a house); a third category may include all session data associated with creditworthiness of a user; and so on, including any combination of category and including instances where some session data is duplicated for use across multiple categories.

To perform the classification task of the orchestration subsystem, the ML model(s) 218 may be pretrained and fine-tuned specifically for classification tasks. The ML model(s) 218, for example, may be trained to identify keywords in the session data when performing the classification. Such ML model(s) may include, for example, DIET models, BERT based models, CNNs, and so on, trained to perform classification tasks on data. In addition to classifying the session data, the ML model(s) 218 included in orchestration subsystem 206 can also cluster the categorized session data using one or more clustering algorithms (e.g., k-means clustering, Density-Based Spatial Clustering of Applications with Noise (“DBSCAN”), hierarchical DBSCAN (“HDBSCAN”), spectral clustering, Gaussian Mixture Models (“GMM”), and so on) to cluster the session data into further refined categories.

After the session data is categorized into respective categorical datasets, virtual assistant platform 210 performs a smart routing on the categorical datasets to provide the categorical datasets via data channel(s) 242 to insights subsystem 202. The smart routing described herein refers to the process of providing each categorical datasets to a respective ML model or set of ML models of ML model(s) 212 that has been pretrained to generate insight(s) 222 associated with a particular type of categorical dataset. For example, a first set of ML model(s) 212 may be pretrained to generate insight(s) 222 associated with intents or goals of the user, another set of ML model(s) 212 may be pretrained to generate insight(s) 222 associated with creditworthiness of the user, and so on. As previously mentioned with respect to FIG. 1, insight(s) 222 refers to a text output that includes advice, recommendations, summarized information, predictions, and so on that are generated using for example, generative language models. In essence, the insight(s) 222 may give the user of client device 130 detailed information associated with all aspects of an account or profile the user of client device 130 maintains with the enterprise hosting the virtual assistant platform 210.

Insight(s) 222 generated by insights subsystem 202 are then provided to scoring engine 208. Scoring engine 208 may score each insight 222 to thereby generate a list of ranked insight(s) 224 where an order of insight(s) 222 included in ranked insight(s) 224 are displayed for client device 130 based on relevancy. In more detail, scoring engine 208 may compute a confidence score associated with each insight of insight(s) 222 using a scoring algorithm following by a threshold analysis performed on the scored insights. The confidence score may be generated using probabilities, log probabilities, the softmax function, or using other similar confidence metrics where insights with a better confidence score are considered more relevant to the user. In other words, the confidence score represents how well the scoring engine 208 believes that the insight will be “of interest” to the user. In addition, score fine tuning 240 may be provided to the scoring engine 208 to fine tune the scoring algorithms. For instance, as described with respect to FIG. 1 and as described in more detail below with respect to the virtual assistant subsystem 204, the user of client device 130 may interact (e.g., tap, click, etc.) on the ranked insight(s) 224. Such feedback 236 may be provided to scoring engine 208 to fine tune the scoring algorithms to bias them towards insights that the user is interacting with the most.

Moreover, it will be appreciated that insights subsystem 202 can generate many insight(s) 222 (e.g., tens, hundreds, or more). Thus, scoring engine 208 may also perform a threshold analysis. More specifically, after generating the confidence score, the confidence score for each scored insight may be compared to a threshold. In some examples, if the confidence score is greater than the threshold, the threshold is satisfied. In this case, the scoring engine 208 may include the insight 222 in the ranked insight(s) 224 for display on the client device 130. In some examples, if the confidence score is less than the threshold, the threshold is not satisfied. In these cases, the scoring engine 208 may discard the insight 222 or otherwise not include the insight 222 in the ranked insight(s) 224. In some examples, additional thresholds may be used. For example, confidence scores for multiple insight(s) 222 may be established to evaluate a difference between the respective confidence scores for the multiple insight(s) 222. If the difference between the multiple insight(s) 222 satisfies a threshold, the scoring engine 208 can output the ranked insight(s) 224 in an order associated with the confidence scores. The ranked insight(s) 224 are then displayed on a GUI of client device 130. Yet another threshold analysis may involve computing a threshold number of ranked insight(s) 224 to display on client device 130 (e.g., ten total insights) and displaying the top ten insights having the best confidence score while discarding the rest.

As mentioned with respect to FIG. 1, a user may interact with the ranked insight(s) 224 such as by clicking, tapping, or otherwise selecting one or more insight(s) to learn more about the insight. As part of this interaction, the user may have questions about the insight, or the user may want to learn more about the insight. In these cases, a user may provide input 234 into a chat box window that is displayed by the virtual assistant platform 210 on the client device 130. As mentioned with respective to FIG. 1, input 234 may be a text input that is typed by the user, it may be an audio message that is recorded by the client device and converted to text via a speech-to-text software, and so on. The input 234 may be in various forms such as in sentence form, paragraph form, bullet points, and so on. Responsive to receipt of the input 234, virtual assistant platform 210 may activate an instance of a virtual assistant hosted by virtual assistant subsystem 204. Virtual assistant subsystem 204 may include NLP 216 and LLM stack 214 to process the input 234.

NLP 216 of virtual assistant subsystem 204 may first perform intent classification on the input 234. As discussed above, intent classification utilizes one or more ML model(s) to determine an underlying purpose or goal of the text input. The intent classification models implemented by NLP 216 are trained on a dataset of user requests paired with their respective intent labels and the intent classification models learns to extract relevant features from the text input, such as keywords, phrases, and grammatical structure. Example intent classification models include DIET models, BERT based models, CNNs, and so on. After extracting the user intent, the virtual assistant subsystem 204 employs LLM stack 214 configured to provide a generative response to the input 234. LLM stack 214 can include trained ML model(s) of any suitable type having been trained to provide natural language responses to text inputs. It will be appreciated that in some cases, the input 234 may be simple enough (e.g., a user is asking for a due date to pay a credit card, an account balance, etc.) that a generative response is not required. In these cases, virtual assistant subsystem 204 may access a list of preconfigured responses from a datastore (not shown) and provide the preconfigured response as the response 226.

Because LLM stack 214 employs suitable ML model(s) which accepts natural language queries and prompts, in some examples LLM stack 214 may be provided with a prompt (not shown) that includes constraints to enable the response 226 to be narrowly tailored according to the preferences of a particular user or administrator of the virtual assistant platform 210. For example, constraints included in prompt may include one or more instructions to provide guidance to the ML model(s) of the LLM stack 214 in generating the response 226. These constraints can include using a particular language (e.g., English), maintaining the same sentence structure as the request, outputting the response 226 in a certain format (e.g., a table, list, paragraph, a certain character length). The constraints may also include general guidance to the ML model(s) of the LLM stack 214 about the language model's role in the response generation such as “You are an excellent assistant for a financial institution.”

In some examples, the constraints may also point the ML model(s) of the LLM stack 214 to additional resources to help aid the ML model(s) of the LLM stack 214 in a response to the input 234. For example, one constraint that may be included in the prompt may instruct the ML model(s) of the LLM stack 214 to consider session data extracted by the orchestration subsystem 206. It will be appreciated that prompting of the ML model(s) of the LLM stack 214 with prompt will help tailor the response(s) 226 to the user's intent in the input 234. Additionally, it will be appreciated that any one or more of the constraints described above may be omitted in some examples or may be ignored by the ML model(s) of the LLM stack 214 and merely serve as guidance to the ML model(s) of the LLM stack 214. Moreover, it will be appreciated that more than one prompt may be provided to ML model(s) of the LLM stack 214. For instance, ML model(s) of the LLM stack 214 may receive a system prompt specifying general guidance and context to the ML model(s) of the LLM stack 214. The system prompt may be predetermined by a system administrator of the virtual assistant platform 210, and as such, the system prompt may be inherent to the virtual assistant platform 210. Additional prompts may be provided to ML model(s) of the LLM stack 214 that may be considered an external input to the virtual assistant platform 210 that may adjust, modify, or otherwise provide additional instructions and constraints to the ML model(s) of the LLM stack 214.

After the input 234 is processed and response(s) 226 is/are generated, the virtual assistant platform 210 monitors for additional inputs from the client device 130. If additional inputs are received (e.g., by virtue of a follow up response from the user or by virtue of the user selecting one or more additional insights), the virtual assistant platform 210 begins the intent classification and generative response generation processing steps again. The virtual interaction with the virtual assistant platform 210 continues until client device 130 disconnects or otherwise times out (e.g., after a period of inactivity, manual disconnection, etc.).

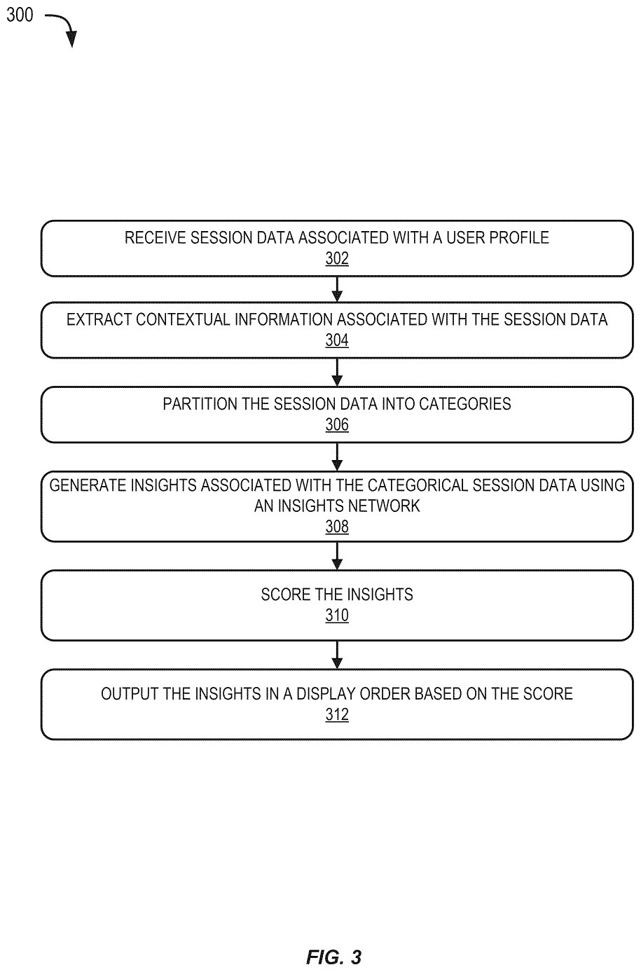

FIG. 3 is a flowchart of an example of a process 300 that provides hyper personalized virtual assistant responses, according to one or more aspects of the present disclosure. The process 300 will be described with respect to the virtual assistant platform 210 shown in FIG. 2; however, any suitable system or platform according to this disclosure may be employed, including the example virtual assistant platform 110 shown in FIG. 1. Additionally, process 300 is provided in the order shown, but other orders or additional steps may be provided.

At block 302, orchestration subsystem 206 receives session data associated with a user profile. Orchestration subsystem 206 may extract the session data in response to a request from client device 130 requesting to initiate a virtual communication session between the virtual assistant platform 210 and the client device 130 where the user is authenticated using authentication 232. To extract the session data, orchestration subsystem may perform parallel processing 244 to extract and receive session data from data source(s) 260, which includes a variety of sources 260A-260N that may store data associated with the user of the client device 130. As mentioned previously with respect to FIG. 2, session data stored in data source(s) 260 can include data associated with a publicly facing website of an enterprise that maintains the virtual assistant platform, transaction history (e.g., deposits, withdrawals, spending, etc.) of an account associated with the user, select documents (e.g., terms and conditions, fee schedules, and the like) associated with an enterprise. Additionally, the session data may dynamically update over time and/or in response to asynchronous changes 252 received from data source manager 250.

At block 304, orchestration subsystem 206 extracts contextual information associated with the session data. More specifically, orchestration subsystem 206 uses ML model(s) 218 to classify the session data into categorical datasets by analyzing the session data to extract keywords and associated with the session data with a particular category. Based on the determined category, the session data can be aggregated into predetermined categories and stored as categorical datasets. As mentioned previously with respect to FIG. 2, categories can include transaction data, goals/intent categories, creditworthiness categories, and so on.

At block 306, orchestration subsystem 206 partitions the session data into categories (e.g., categorical datasets). Following classification of the session data described with respect block 304, the orchestration subsystem 206 partitions the data into appropriate categorical datasets. Based on these categorical datasets, virtual assistant platform 210 performs a smart routing to provide the categorical datasets via data channel(s) 242 to insights subsystem 202. The smart routing described herein refers to the process of providing each categorical datasets to a respective ML model or set of ML models of ML model(s) 212 having been pretrained to generate insight(s) 222 associated with each categorical dataset. Additionally, orchestration subsystem 206 can also cluster the categorized session data using one or more clustering algorithms to further refined the categorical datasets.

At block 308, insights subsystem 202 generates insight(s) 222 associated with the categorical datasets using an insights network comprising one or more ML model(s) 212. As previously mentioned with respect to FIG. 1, insight(s) 222 refers to a text output that includes advice, recommendations, summarized information, predictions, and so on generative using for example, generative language models such as LLMs. In essence, the insight(s) 222 may give the user of client device 130 detailed information associated with all aspects of an account or profile the user of client device 130 maintains with the enterprise hosting the virtual assistant platform 210.

At block 310, scoring engine 208 scores the insight(s) 222 to generate ranked insight(s) 224. As mentioned with respect to FIG. 2, scoring engine 208 may score each insight 222 to thereby generate a list of ranked insight(s) 224 where an order of insight(s) 222 included in ranked insight(s) 224 are displayed for client device 130 based on relevancy. The determined relevancy may be based on a confidence score metric computing using probabilities, log probabilities, the softmax function, or using other similar confidence metrics where insight(s) 222 with a better confidence score are considered more relevant and of interest to the user. In additional processing steps, scoring engine may undergo score fine tuning 240 to further refine the scoring algorithms. Such fine tuning can include incorporating feedback 236 into the scoring algorithms to bias the scoring engine 208 to insight(s) 222 that are more frequency selected by the user.

At block 312, the ranked insight(s) 224 are output to client device 130 in a display order based on the score. In other words, ranked insight(s) 224 with the best confidence score are displayed first on the client device 130. According to one example, the ranked insight(s) 224 may be displayed in a list on the client device 130. In these examples, the ranked insight(s) 224 with the best (e.g., highest) confidence score may be at the top (or in a first position) on the list. The subsequent ranked insight(s) 224 may be display in descending order. Additionally, display of the ranked insight(s) 224 may include only a subset (e.g., a top ten insights with the best confidence scores) of the insight(s) 222. After display of the ranked insight(s) 224, a user may interact with the ranked insight(s) 224 such as by clicking, tapping, or otherwise selecting one or more insight(s) to learn more about the ranked insight(s) 224.

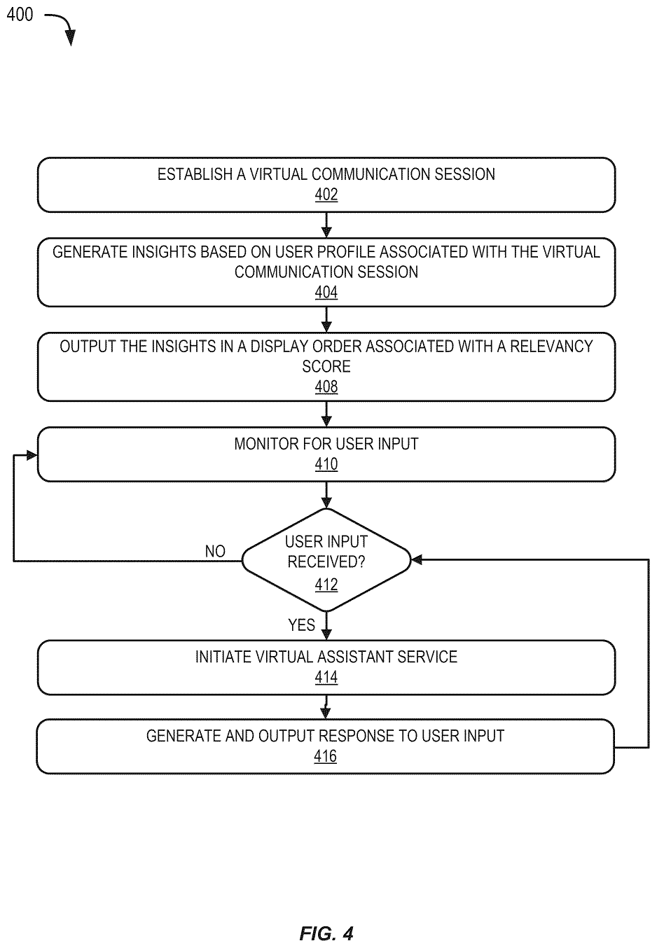

FIG. 4 is a flowchart of an example of a process 400 that provides hyper personalized virtual assistant responses, according to one or more aspects of the present disclosure. Similar to process 300 described with respect to FIG. 3, the example process 400 will be described with respect to the virtual assistant platform 210 shown in FIG. 2; however, any suitable system or platform according to this disclosure may be employed, including the example virtual assistant platform 110 shown in FIG. 1. Additionally, process 400 is provided in the order shown, but other orders or additional steps may be provided.

At block 402, a virtual communication session between client device 130 and virtual assistant platform 210 is established. As mentioned with respect to FIG. 2, the virtual communication session can be established in response to a request from client device 130 requesting to initiate a virtual communication session between the virtual assistant platform 210 and the client device 130 where the user is authenticated using authentication 232. Authentication 232 can involve authenticating the user of the client device using one or more of a username, password, biometrics, and/or any combination thereof (e.g., multi-factor authentication).

At block 404, insights subsystem 202 can generate insight(s) 222 based on a user profile and session data associated with the user of the virtual communication session. As mentioned with respect to FIG. 2, insight(s) 222 refers to a text output that includes advice, recommendations, summarized information, predictions, and so which may be generated using one or more generative models such as ML model(s) 212 of the insights network. Further, the insight(s) 222 may be scored using scoring engine 208. Scoring engine 208 may score each insight to thereby generate a list of ranked insight(s) 224 where an order of insight(s) 222 included in ranked insight(s) 224 are displayed for client device 130 based on relevancy, and the confidence score may be generated using probabilities, log probabilities, the softmax function, or using other similar confidence metrics where insights with a better confidence score are considered more relevant to the user.

At block 406, the virtual assistant platform 210 monitors for user input 234. After providing the ranked insight(s) 224 to the client device 130, the user may view the ranked insight(s) 224. During viewing the user may interact with the ranked insight(s) 224 by selecting (e.g., clicking, tapping, etc.) one or more insights. As such, the virtual assistant platform 210 monitors for such interaction by the user.

At block 412, virtual assistant platform 210 determines if a user input 234 is received. The input 234 may be a text input that is typed by the user, it may be an audio message that is recorded by the client device and converted to text via a speech-to-text software, and so on. The input 234 may be in various forms such as in sentence form, paragraph form, bullet points, and so on. If no input 234 is received, process 400 loops back to block 410 to continuous monitor for user input 234.

In the case where a user input 234 is received, process 400 proceeds to block 414 to initiate virtual assistant subsystem 204. As described above, virtual assistant subsystem 204 may include NLP 216 and LLM stack 214 to process the input 234 and provide generative response(s) 226 in response to the input 234.

After initiation of the virtual assistant subsystem 204, process 400 proceeds to block 416 to generate and output response(s) 226 to the user input 234. More specifically, NLP 216 may first perform intent classification on the input 234 where the language models of NLP 216 are trained on a dataset of user inputs paired with their respective intent labels. After extracting the user intent, the virtual assistant subsystem 204 employs LLM stack 214 configured to provide a generative response to the input 234. After the response(s) 226 is/are generated, process 400 loops back to block 412 to determine if a new user input is received. The virtual interaction with the virtual assistant platform continues until client device 130 disconnects or otherwise times out (e.g., after a period of inactivity, manual disconnection, etc.)

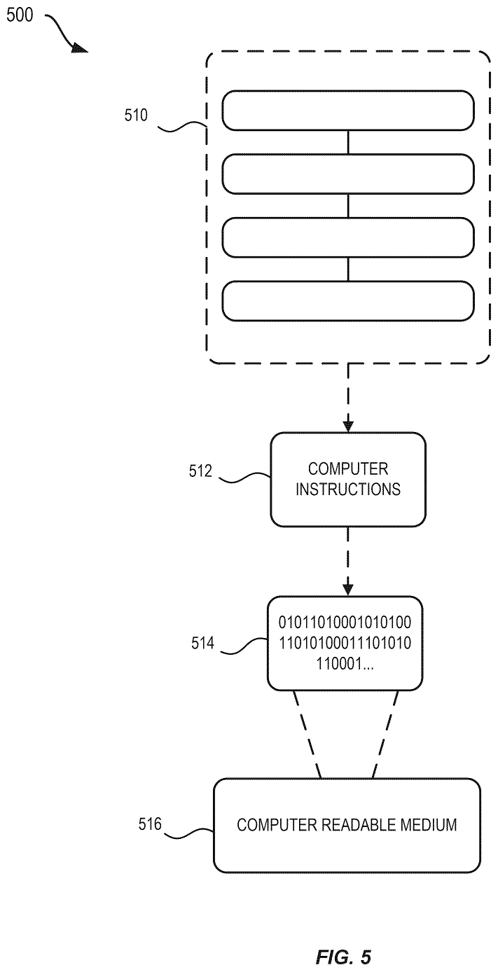

One or more of the aspects of the present disclosure include a computer-readable medium including microprocessor or processor-executable instructions configured to implement one or more embodiments presented herein. FIG. 5 is a block diagram illustrating an example computer-readable medium or computer-readable device including processor-executable instructions configured to embody one or more of the aspects set forth herein. As illustrated in FIG. 5, implementation 500 includes a computer-readable medium 516. Computer-readable medium 516 can include a CD-R, DVD-R, flash drive, a platter of a hard disk drive, and so forth, on which computer-readable data 514 is encoded and stored. The computer-readable data 514, such as binary data including a plurality of zero's and one's as illustrated, in turn includes a set of computer instructions 512 configured to operate according to one or more of the principles set forth herein.

In the illustrated implementation 500 of FIG. 5, the set of computer instructions 512 (e.g., processor-executable computer instructions) may be configured to perform a method 510, such as the process 300 of FIG. 3 or the process 400 of FIG. 4, for example. In another embodiment, the set of computer instructions 512 may be configured to implement a system or platform, such as the virtual assistant platform 110 described with respect to FIG. 1 or the virtual assistant platform 210 described with respect to FIG. 2, for example. Many such computer-readable media may be devised by those of ordinary skill in the art that are configured to operate in accordance with the techniques presented herein.

As used in this application, the terms “component,” “module,” “system,” “interface,” “manager,” “engine,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

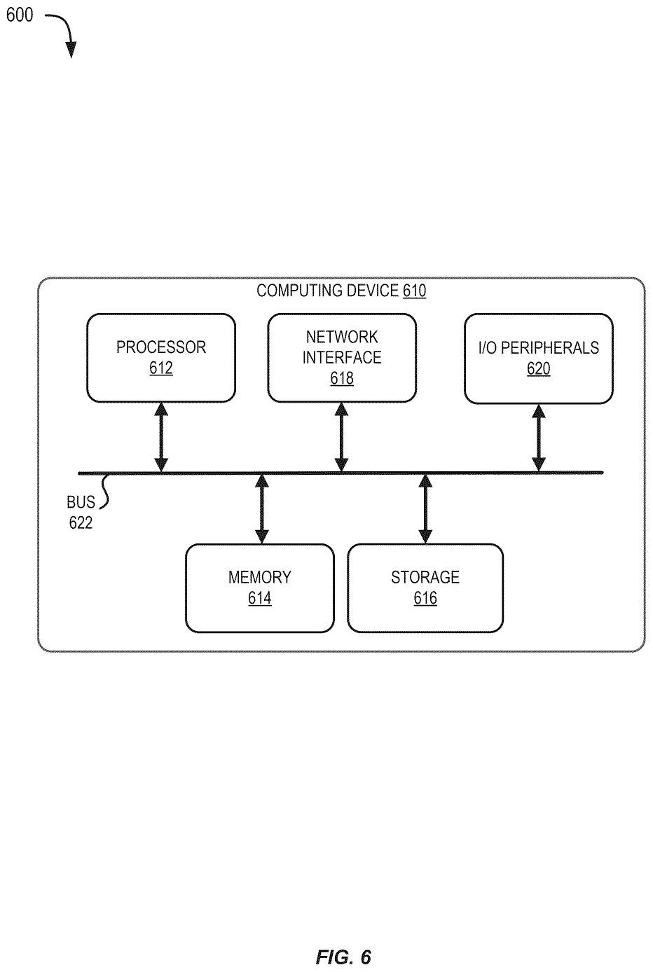

FIG. 6 and the following discussion provide a description of a suitable computing environment 600 to implement embodiments of one or more aspects of the present disclosure. The computing environment 600 of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, application programming interfaces (APIs), data structures, and the like, which perform one or more tasks or implement one or more abstract data types. Typically, the functionality of the computer readable instructions is combined or distributed as desired in various environments.

FIG. 6 is a block diagram illustrating an example computing environment 600 configured to provide hyper personalized virtual assistant responses, according to one or more aspects of the present disclosure. In one configuration, the computing device 610 may include at least one processor 612 and at least one memory 614. Depending on the exact configuration and type of computing device, the at least one memory 614 may be volatile, such as RAM, non-volatile, such as ROM, flash memory, etc., or a combination thereof. Examples of processor 612 include a microprocessor, an application-specific integrated circuit (ASIC), a field-programmable gate array (FPGA), or any other suitable processing device. Computing device 610 can include one processor, such as is illustrated by processor 612 in FIG. 6, or more than one processor.

Computing device 610 may include additional features or functionality. For example, the computing device 610 may include storage such as removable storage or non-removable storage, including, but not limited to, magnetic storage, optical storage, etc. Such storage is illustrated in FIG. 6 by storage 616. In one or more embodiments, computer readable instructions to implement one or more embodiments provided herein are in the storage 616. The storage 616 may store other computer readable instructions to implement an operating system, an application program, etc. Computer readable instructions may be loaded in the at least one memory 614 for execution by the at least one processor 612, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 6, the computing environment 600 may also include a number of additional external or internal devices, for example, input or output devices. For example, computing device 610 is illustrated as including input/output (I/O) peripherals 620. I/O peripherals 620 can receive input from an input device (not shown) or provide output to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device 610.

I/O peripherals 620 may be connected to the computing device 610 via a wired connection, wireless connection, or any combination thereof. Further, the computing device 610 may include network interface 618 to facilitate communications with one or more other devices (not shown). Network interface 618 can include any device or group of devices suitable for establishing a wired or wireless data connection to one or more data networks. Non-limiting examples of the network interface 618 include an Ethernet network adaptor, a wireless network adapter, a modem, Wi-Fi adapter, Bluetooth adapter, near field communication (NFC) receiver and transmitter, and any other known wired or wireless data transmission system.

Computing device 610 also includes bus 622. Although only one interface bus is illustrated, computing environment 600 can include more than one interface bus. Bus 622 can communicatively couple one or more components of computing device 610. Computing environment 600 also includes one or more programs and/or program data that may be accessible in storage 616 by the computing device 610. For example, storage 616 can store an operating system utilized to control the operation of the computing device 610. Storage 616 can also store other system application programs and data utilized by the computing device 610, such as modules implementing the functionalities provided by the virtual assistant platform 110 or the virtual assistant platform 210 or any other functionalities described above with respect to FIGS. 1-4. The storage 616 may also store other programs and data not specifically identified herein.

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method comprising:
establishing a virtual communication session with a user having a user profile;
extracting, based on the user profile, session data associated with the user from a plurality of data sources;
determining, using an orchestration model comprising at least one machine learning (ML) model, contextual information associated with the session data;
partitioning, using the orchestration model and based on the determined contextual information, the session data into one or more predefined categories thereby creating a plurality of categorical datasets;
generating, using an insights network comprising a plurality of ML models, a plurality of insights for each categorical dataset of the plurality of categorical datasets;
scoring, using a scoring algorithm, each insight of the plurality of insights, wherein a respective score of each insight is associated with a respective probability that the insight is of interest to the user;
identifying a first insight as a best insight based on the respective probability of the first insight being a best score of a plurality of scores; and
outputting, for display on a user interface, the plurality of insights in a display order based on the score, wherein the display order prioritizes the first insight.

2. The method of claim 1, wherein the plurality of ML models of the insights network are subdivided into separate subsystems, each ML model of each subsystem being fine-tuned to generate insights for a particular predefined category of the one or more predefined categories, and wherein the orchestration model performs a smart routing on the plurality of categorical datasets to provide each respective categorical dataset to a subsystem fine-tuned for the particular predefined category associated with the respective categorical dataset.

3. The method of claim 1, further comprising:
receiving, responsive to outputting the plurality of insights, an input from the user, the input comprising a selection of an insight from the plurality of insights and a text input;
initiating, responsive to receiving the input, a virtual assistant service, the virtual assistance service configured to:
extract, using an intent classification model, an intent associated with the text input, the intent being associated with a goal or purpose of the user and being associated with the selected insight; and
generate and output, using a generative model and based on the intent, a response.

4. The method of claim 3, further comprising:
providing one or more constraints to the generative model, wherein the one or more constraints are not visible to the user and are provided to the generative model prior to initiation of the virtual assistant service but after establishment of the virtual communication session, wherein the one or more constraints comprise:
(1) a first constraint to consider the session data;
(2) a second constraint to consider data associated with a webpage of an enterprise;
(3) a third constraint to use a specific dialect of a language that matches a predefined language of the user profile; and
(4) a fourth constraint to analyze the text input for a number of characters and responsive to the number of characters satisfying a threshold, outputting an indication that the text input is not compliant.

5. The method of claim 1, wherein the user selects an insight from the plurality of insights, wherein selecting the insight results in display of additional information associated with the insight, and wherein the method further comprises:
fine-tuning the scoring algorithm based on a history of insight selections performed by the user, wherein fine-tuning the scoring algorithm includes updating one or more parameters of the scoring algorithm to bias the scoring algorithm to one or more predefined categories.

6. The method of claim 1, wherein the session data dynamically updates for each new virtual communication session based on a predefined timing period.

7. The method of claim 1, further comprising:
evaluating each respective score of the plurality of insights against one or more thresholds;
responsive to determining a respective score satisfies the one or more thresholds, outputting the insight for display to the user; and
responsive to determining a respective score does not satisfy the one or more thresholds, discarding the insight.

8. A system comprising:
one or more processors;
a memory coupled to the one or more processors, the memory including instructions that, when executed by the one or more processors, cause the one or more processors to:
establish a virtual communication session with a user having a user profile;
extract, based on the user profile, session data associated with the user from a plurality of data sources;
determine, using an orchestration model comprising at least one machine learning (ML) model, contextual information associated with the session data;
partition, using the orchestration model and based on the determined contextual information, the session data into one or more predefined categories thereby creating a plurality of categorical datasets;
generate, using an insights network comprising a plurality of ML models, a plurality of insights for each categorical dataset of the plurality of categorical datasets;
score, using a scoring algorithm, each insight of the plurality of insights, wherein a respective score of each insight is associated with a respective probability that the insight is of interest to the user;
identify a first insight as a best insight based on the respective probability of the first insight being a best score of a plurality of scores; and
output, for display on a user interface, the plurality of insights in a display order based on the score, wherein the display order prioritizes the first insight.

9. The system of claim 8, wherein the plurality of ML models of the insights network are subdivided into separate subsystems, each ML model of each subsystem being fine-tuned to generate insights for a particular predefined category of the one or more predefined categories, and wherein the orchestration model performs a smart routing on the plurality of categorical datasets to provide each respective categorical dataset to a subsystem fine-tuned for the particular predefined category associated with the respective categorical dataset.

10. The system of claim 8, wherein the instructions further cause the one or more processors to:
receive, responsive to outputting the plurality of insights, an input from the user, the input comprising a selection of an insight from the plurality of insights and a text input;
initiate, responsive to receiving the input, a virtual assistant service, the virtual assistance service configured to:
extract, using an intent classification model, an intent associated with the text input, the intent being associated with a goal or purpose of the user and being associated with the selected insight; and
generate and output, using a generative model and based on the intent, a response.

11. The system of claim 10, wherein the instructions further cause the one or more processors to:
provide one or more constraints to the generative model, wherein the one or more constraints are not visible to the user and are provided to the generative model prior to initiation of the virtual assistant service but after establishment of the virtual communication session, wherein the one or more constraints comprise:
(1) a first constraint to consider the session data;
(2) a second constraint to consider data associated with a webpage of an enterprise;
(3) a third constraint to use a specific dialect of a language that matches a predefined language of the user profile; and
(4) a fourth constraint to analyze the text input for a number of characters and responsive to the number of characters satisfying a threshold, outputting an indication that the text input is not compliant.

12. The system of claim 8, wherein the user selects an insight from the plurality of insights, wherein selecting the insight results in display of additional information associated with the insight, and wherein the instructions further cause the one or more processors to:
fine-tune the scoring algorithm based on a history of insight selections performed by the user, wherein fine-tuning the scoring algorithm includes updating one or more parameters of the scoring algorithm to bias the scoring algorithm to one or more predefined categories.

13. The system of claim 8, wherein the session data dynamically updates for each new virtual communication session based on a predefined timing period.

14. The system of claim 8, wherein the instructions further cause the one or more processors to:
evaluate each respective score of the plurality of insights against one or more thresholds;
responsive to determining a respective score satisfies the one or more thresholds output the insight for display to the user; and
responsive to determining a respective score does not satisfy the one or more thresholds discard the insight.

15. A non-transitory computer-readable medium embodying program code that is executable by one or more processors to cause the one or more processors to:
establish a virtual communication session with a user having a user profile;
extract, based on the user profile, session data associated with the user from a plurality of data sources;
determine, using an orchestration model comprising at least one machine learning (ML) model, contextual information associated with the session data;
partition, using the orchestration model and based on the determined contextual information, the session data into one or more predefined categories thereby creating a plurality of categorical datasets;
generate, using an insights network comprising a plurality of ML models, a plurality of insights for each categorical dataset of the plurality of categorical datasets;
score, using a scoring algorithm, each insight of the plurality of insights, wherein a respective score of each insight is associated with a respective probability that the insight is of interest to the user;
identify a first insight as a best insight based on the respective probability of the first insight being a best score of a plurality of scores; and
output, for display on a user interface, the plurality of insights in a display order based on the score, wherein the display order prioritizes the first insight.

16. The non-transitory computer-readable medium of claim 15, wherein the plurality of ML models of the insights network are subdivided into separate subsystems, each ML model of each subsystem being fine-tuned to generate insights for a particular predefined category of the one or more predefined categories, wherein the orchestration model performs a smart routing on the plurality of categorical datasets to provide each respective categorical dataset to a subsystem fine-tuned for the particular predefined category associated with the respective categorical dataset, and wherein the session data dynamically updates for each new virtual communication session based on a predefined timing period.

17. The non-transitory computer-readable medium of claim 15, further comprising program code that is executable by the one or more processors to cause the one or more processors to:
receive, responsive to outputting the plurality of insights, an input from the user, the input comprising a selection of an insight from the plurality of insights and a text input;
initiate, responsive to receiving the input, a virtual assistant service, the virtual assistance service configured to:
extract, using an intent classification model, an intent associated with the text input, the intent being associated with a goal or purpose of the user and being associated with the selected insight; and
generate and output, using a generative model and based on the intent, a response.

18. The non-transitory computer-readable medium of claim 17, further comprising program code that is executable by the one or more processors to cause the one or more processors to:
provide one or more constraints to the generative model, wherein the one or more constraints are not visible to the user and are provided to the generative model prior to initiation of the virtual assistant service but after establishment of the virtual communication session, wherein the one or more constraints comprise:
(1) a first constraint to consider the session data;
(2) a second constraint to consider data associated with a webpage of an enterprise;
(3) a third constraint to use a specific dialect of a language that matches a predefined language of the user profile; and
(4) a fourth constraint to analyze the text input for a number of characters and responsive to the number of characters satisfying a threshold, outputting an indication that the text input is not compliant.

19. The non-transitory computer-readable medium of claim 15, wherein the user selects an insight from the plurality of insights, wherein selecting the insight results in display of additional information associated with the insight, and further comprising program code that is executable by the one or more processors to cause the one or more processors to:
fine-tune the scoring algorithm based on a history of insight selections performed by the user, wherein fine-tuning the scoring algorithm includes updating one or more parameters of the scoring algorithm to bias the scoring algorithm to one or more predefined categories.

20. The non-transitory computer-readable medium of claim 15, further comprising program code that is executable by the one or more processors to cause the one or more processors to:
evaluate each respective score of the plurality of insights against one or more thresholds;
responsive to determining a respective score satisfies the one or more thresholds output the insight for display to the user; and
responsive to determining a respective score does not satisfy the one or more thresholds discard the insight.
